(19) United States
(12) Patent Application Publication
(10) Pub. No.: US 2024/0113586 A1
(43) Pub. Date: Apr. 4, 2024

(54) ELECTRICAL WINDING ELEMENT

(71) Applicant: UNIVERSITY OF BRISTOL, Bristol Bristol (GB)

(72) Inventor: Nick SIMPSON, Bristol Bristol (GB)

(21) Appl. No.: 18/264,812

(22) PCT Filed: Feb. 7, 2022
(86) PCT No.: PCT/EP2022/052910

§ 371 Date: Aug. 9, 2023

(30) Foreign Application Priority Data
Feb. 9, 2021 (GB) 2101766.0

(51) Int. Cl. H02K 3/42; H02K 3/14

(52) U.S. Cl. CPC H02K 3/42; H02K 3/14

(57) ABSTRACT

An electrical winding element for an electrical machine can have a first end portion with a first single elongate conductive member; a second end portion with a second single elongate conductive member; and an intermediate portion with a plurality of intermediate conductive members arranged in an electrically parallel arrangement to conductively connect between the first end portion and the second end portion. A stator and an electrical machine are also disclosed.

### PRIORITY CLAIM

The present application is a National Phase entry of PCT Application No. PCT/EP2022/052910, filed Feb. 7, 2022, which claims priority from GB Application No. 2101766.0, filed Feb. 9, 2021, each of which is hereby fully incorporated herein by reference.

### TECHNICAL FIELD

The present application relates to an electrical winding element. The present application also relates to a stator and an electrical machine.

### BACKGROUND

Electrical machines typically comprise windings, also known as coil windings, to form electromagnetic coils. Windings provide the magnetic field of, for example, motors, generators and transformers. A stator of a rotary system may comprise windings and a stator core. Windings may take different winding configurations. A rotor of a rotary system may comprise windings.

### SUMMARY

According to an aspect, there is provided an electrical winding element for an electrical machine comprising: a first end portion comprising a first single conductive member; a second end portion comprising a second single conductive member; and an intermediate portion conductively connected between the first end portion and the second end portion comprising a plurality of intermediate conductive members arranged in an electrically parallel arrangement.

This arrangement helps to reduce eddy current losses within the conductive members, known as the skin effect, which are induced when carrying a changing electric current.

The plurality of intermediate conductive members may be transposed.

This arrangement aids reductions in parasitic circulating currents. Such an arrangement helps to reduce losses and to improve efficiency of electrical machines. By providing the plurality of intermediate conductive members arranged in an electrically parallel arrangement helps to ensure that voltages induced between intermediate conductive members are balanced and that circulating currents are minimized, and so losses are minimized.

Providing single conductive members at an end portion aids manufacture of winding configurations from a plurality of winding elements.

The first single conductive member may be elongate. The second single conductive member may be elongate. Each intermediate conductive member may be elongate.

As used herein, the term ‘electrically parallel arrangement’ means an arrangement forming a plurality of electrical paths, in which the features forming the electrically parallel arrangement are not necessarily in a physically parallel arrangement.

As used herein, the term ‘conductively connected between’ does not necessarily mean that two features are directly connected between, and such an arrangement may include one or further features therebetween.

The plurality of intermediate conductive members may be congruent. Each intermediate conductive member may be helical. Such a helical arrangement may be, for example a rectangular helix, a circular helix, or another helical configuration. The plurality of intermediate conductive members may form a multi-helical arrangement.

The first end portion may define a single electrically conductive path. The second end portion may define a single electrically conductive path.

The first end portion may be a solid member. The second end portion may be a solid member. Each intermediate conductive member may be a solid member.

The electrical winding element may comprise a first leg with the first end portion; a second leg with the second end portion; and an end turn portion between the first and second legs.

The electrical winding element may comprise a plurality of end turn portions. At least one of the first end portion and the second end portion may be an end turn portion. At least one of the first end portion and the second end portion may define a turn portion between legs.

The intermediate portion may be defined in the first leg between the first end portion and the end turn.

The end turn portion may comprise a single conductive member.

The end turn portion may define a single electrically conductive path.

The end turn portion may be a solid member.

The intermediate portion may be a first intermediate portion, and the electrical winding element may comprise a second intermediate portion defined in the second leg comprising a plurality of second intermediate conductive members arranged in an electrically parallel arrangement.

The second leg may extend at least substantially parallel to the first leg.

The first end portion, second end portion, and the or each intermediate portion may be formed as a one piece component.

The first end portion, second end portion, and the or each intermediate portion may be integrally formed.

The first end portion, second end portion, and the or each intermediate portion may together define a conductive arrangement, and the electrical winding element may comprises an insulative arrangement.

The insulative arrangement may electrically insulate between the plurality of elongate conductive members.

As used herein, the term ‘electrically insulates’ means a material that has a greater electrically insulative value than the material of the plurality of elongate conductive members.

The insulative arrangement may separate adjacent conductive members of the plurality of elongate conductive members.

The insulative arrangement may comprise an insulative core.

The insulative core may extend along the length of the intermediate portion.

The insulative core may extend along the length of at least one of the first end portion and the second end portion. The insulative core may extend along the length of the end turn portion.

The insulative core may extend along the length of the electrical winding element.

The intermediate elongate portion may comprise a transposed arrangement. The plurality of elongate conductive members may comprise a helical arrangement.

The intermediate portion may comprise at least two intermediate segments. The at least two intermediate segments may be disposed adjacent to each other in an elongate axial direction.

The intermediate portion may comprise a baffle segment between adjacent intermediate segments of the at least two intermediate segments.

The or each baffle segment may extend perpendicular to an elongate axis of the intermediate portion.

At least one intermediate segment may comprise a different geometry to the or at least one of the other intermediate segments.

A transition segment may be between at least two intermediate segments. The geometry may transition between the geometry of the at least two intermediate segments in the transition segment.

The different geometry may comprise a different pitch.

The intermediate section may have a rectangular profile.

The electrical winding element may have a substantially constant cross-sectional area along the length of the electrical winding element.

The electrical winding element may be a hairpin winding element.

Each of the conductive members may comprise a rectangular profile.

According to an aspect, there is provided a stator for an electrical machine comprising a plurality of electrical winding elements of any preceding claim.

According to an aspect, there is provided a rotor for an electrical machine comprising a plurality of electrical winding elements of any preceding claim.

According to an aspect, there is provided a stator for an electrical machine comprising: a stator core defining an active length; an electrical winding element having a first solid conductive end extending from the stator core, a second solid conductive end extending from the stator core, and an active section between the first and second ends, wherein the active section comprises an elongate transposed conductive section at least substantially along the length of the active length of the stator core.

The length of the elongate transposed conductive section may be greater than the length of the active length of the stator core. Such an arrangement may help with allowing flux in a fringing field outside of the active length to be captured by the transposed section to further balance currents. The length of the elongate transposed conductive section may be less than the length of the active length of the stator core. Having a portion of a solid conductive end extending within the active length at each end may aid to limit and/or prevent damage being caused by a bending or twisting operation on the transposed conductive section.

The first solid conductive end may define a joining end portion for joining to an adjacent joining end portion of an adjacent electrical winding element, and wherein the second solid conductive end defines an end turn portion.

The electrical winding element may be a hairpin element comprising a first leg, a second leg and the end turn portion between the first and second legs, wherein the elongate transposed conductive section is on the first leg.

The elongate transposed conductive section may be a first elongate transposed conductive section. A second elongate transposed conductive section may be on the second leg.

The first leg may be a radially inner leg and the second leg may be a radially outer leg. The stator may be an outer stator.

The first leg may be a radially outer leg and the second leg may be a radially inner leg. The stator may be an inner stator.

According to an aspect, there is provided an electrical machine comprising at least one of the electrical winding element as described above.

The electrical machine may comprise a rotor and a stator. An air gap may be defined between the rotor and the stator. The first leg may be an air gap proximal leg. The second leg may be an air gap distal leg. That is, the first leg is closer to the air gap than the second leg.

According to an aspect, there is provided an electrical machine comprising at least one of the stator as described above and the rotor as described above.

According to an aspect, there is provided an electrical winding element for an electrical machine comprising: a first solid conductive end section; a second solid conductive end section; and a transposed conductive intermediate elongate section conductively connected between the first and second solid conductive end sections.

These and other advantages and features will become more apparent from the following description taken in conjunction with the drawings.

### BRIEF DESCRIPTION OF THE DRAWINGS

Embodiments of the disclosure are further described, by way of example only, by reference to the accompanying drawings in which:

FIG. 1 is a schematic plan view of an electrical motor.

FIG. 2 is a perspective view of a winding of the electrical motor of FIG. 1 comprising a plurality of winding elements.

FIG. 3 is a perspective view of a winding element of the winding of FIG. 2.

FIG. 4 is a cross-sectional side view of a stator including the winding of FIG. 2.

FIG. 5 is a front view of part of a leg of the winding element of FIG. 3.

FIG. 6 is a side view of part of the leg of the winding element of FIG. 3.

FIG. 7 is a close up side view of the part of the leg of FIG. 6.

FIG. 8 is a cross-sectional view through an end portion of the leg of the winding element of FIG. 3.

FIG. 9 is a cross-sectional view through an intermediate portion of the leg of the winding element of FIG. 3.

FIG. 10 is a cross-sectional view through another embodiment of an end portion of the leg of the winding element of FIG. 3.

FIG. 11 is a side view of part of a leg of another embodiment of a winding element.

FIG. 12 is a close up side view of the part of the leg of FIG. 11.

FIG. 13 is a side view of part of a leg of another embodiment of a winding element.

FIG. 14 is a cross-sectional side view of another embodiment of a stator.

FIG. 15 is a perspective view of a winding element of the stator of FIG. 14.

### DETAILED DESCRIPTION

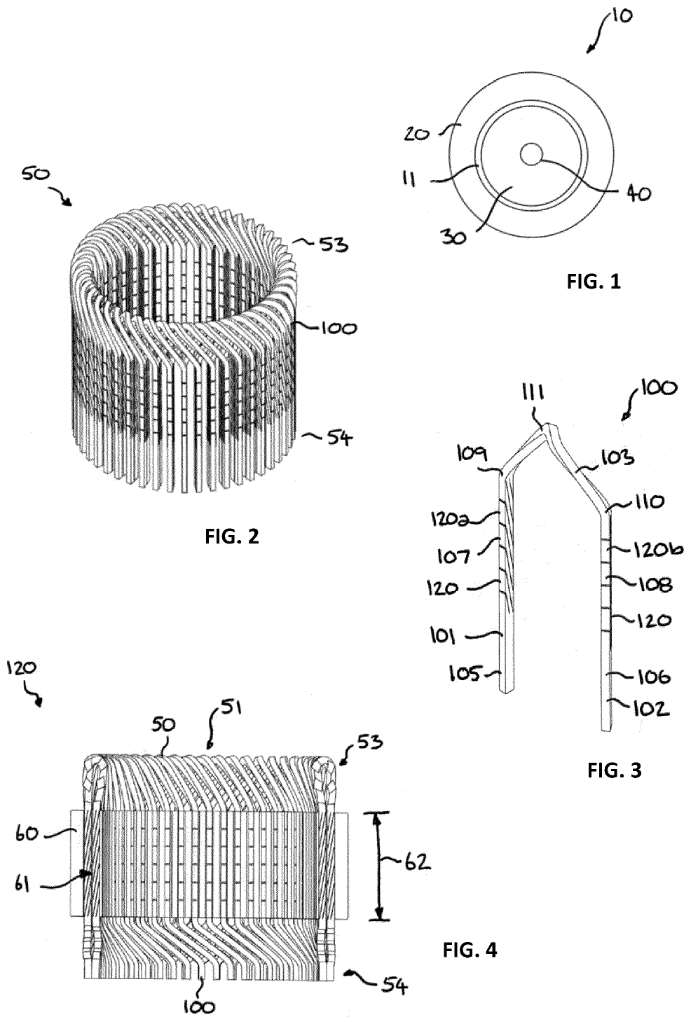

An electrical motor 10 is shown in FIG. 1. The electrical motor 10 comprises a stator 20 and a rotor 30. A shaft 40 extends from the rotor 30. An air gap 11 is defined between the stator and the rotor 30. The electrical motor 10 is a rotating machine. The electrical motor 10 is an electrical machine. The electrical motor 10 may be used in a number of applications, for example electric vehicle traction, ancillary motors, aircraft generators, electric aircraft propulsors, marine applications, and other industrial and domestic applications.

Although configurations are described herein by reference to electrical motors, it will be understood that configurations may be applied to other electrical machines, for example generators and inductors. Furthermore, such configurations are not limited to stator windings and in embodiments are applied to rotor windings. Furthermore, configurations are described herein with reference to an external stator, however it will be understood that other arrangements are envisaged, for example configurations with an internal stator. Although described herein with respect to a rotary system, it will be understood that configurations may be applied to a linear system.

A winding 50 of the electrical motor 10 is shown in FIG. 2. The winding 50 comprises an array 51 of winding elements 100. The array 51 comprises a plurality of the winding elements 100, also known as winding members. One such winding element 100 is shown in FIG. 3. The stator 20 of the electrical motor 10 is shown in FIG. 4. The stator 20 comprises the winding 50 and a core pack 60, also known as a core. The array 51 of winding elements 100 forms an annulus.

Each winding element 100 forms a turn of the winding 50. Adjacent winding elements 100 are electrically connected to each other. The winding 50 is a hairpin winding, with each winding element 100 forming a hairpin winding element. Other configurations are envisaged. For example, the winding in embodiments is a concentrated winding. The or each winding element in such an embodiment includes a plurality of turns. The turns may have a common magnetic axis. Multiple concentrated coils may be connected electrically in series and/or parallel, to form groups/phases. The concentrated coils may be connected individually, or in groups/phases. The winding elements 100 are received in corresponding stator slots 61 in the core pack 60. Each winding element 100 is slid into the corresponding stator slot 61 to align the winding element 100. Accordingly, the winding elements 100 are supported in their desired configuration. In embodiments, the winding elements 100 may be slid onto members, such as teeth to locate and support the winding elements 100. In an alternative embodiment, the stator is a slotless configuration, for example with a formed support, for example using one or more of fiberglass, a composite, and epoxy, providing mechanical support to the windings. The winding may be encapsulated.

In a hairpin winding configuration, as shown in FIG. 3, the winding element 100 comprises a first leg 101 and a second leg 102. The first and second legs 101, 102 extend substantially parallel to each other. An end turn portion 103 extends between the first and second legs 101, 102. The end turn portion 103 links the first and second leg portions 101, 102. The first leg 101 abuts a second leg portion 102 of an adjacent winding element 100. The first and second legs 101, 102 are rotated relative to each other to aid alignment of abutting first and second legs 101, 102 to form the annulus of winding elements 100. The number of legs may differ. In embodiments, the number of legs per slot may differ. The geometry of the end turn portions in embodiments may differ between winding elements.

The winding element 100 comprises a first end portion 105 and a second end portion 106. The first end portion 105 is at a free end of the first leg 101. The second end portion 106 is at a free end of the second leg 102. The first and second legs 101, 102 extend along substantially linear axes. The leg axes extend parallel, but spaced from, each other. The substantially linear axes aid insertion into the stator slots, however it will be understood that the configuration of the legs may vary, and may include a bend or arcuate configuration.

The end turn portion 103 extends between the first and second legs 101, 102. The end turn portion 103 has a generally V-shaped configuration. The V-shaped configuration spaces the first and second legs 101, 102. The end turn portion 103 comprises a first bend 109 at a juncture with the first leg 101 and a second bend 110 at a juncture with the second leg. A central bend 111 is defined at a mid-point of the end turn portion 103. It will be understood that the end turn portion 103 may have a different configuration, such as an arcuate arrangement, extending between the first and second legs 101, 102. In some embodiments, in which the winding element comprises a plurality of turns, for example a concentrated winding, one or both of the first and second end portions 105, 106 are end turn portions. With such an arrangement the end portions are not formed as free ends. Such end portions are turn portions between legs.

As shown in FIG. 4, when assembled each winding element 100 of the array 51 is received by the core pack 60. The stator 20 defines an active length 62, also known as a core section. The active length 62 is substantially defined by the length of the core pack 60. The winding element 100 protrudes from the core pack 60 at each end. The end turn portion 103 extends from one side of the core pack 60 and the first and second portions 105, 106 extend from an opposing side of the core pack 60. The end turn portion side of the winding 100 defines an end turn section 53. The first and second portion side of the winding 100 defines a juncture section 54. The active length 62 is defined between the end turn section 53 and the juncture section 54. In the arrangement shown in FIG. 4, the winding elements 100 of the array 51 are shown in a formed position. The winding elements 100 of FIG. 4 are formed by manipulating the arrangement in FIG. 2. In embodiments, the winding elements 100 do not require a further forming step. Adjacent first and second portions 105, 106 of adjacent winding elements 100 are adjoined at the juncture section 54. The first and second portions 105, 106 of adjacent winding elements 100 are adjoined by joining techniques such as brazing, welding, mechanical fastening and soldering. The first and second portions 105, 106 of adjacent winding elements 100 in embodiments are integrally formed. That is, the features are not separable. In embodiments, the first and second portions 105, 106 of adjacent winding elements 100 are formed as a one piece component. That is the winding elements are formed together, for example by additive manufacturing, such that no joints are defined between winding elements, also known as winding members. Such an arrangement may form a helical winding.

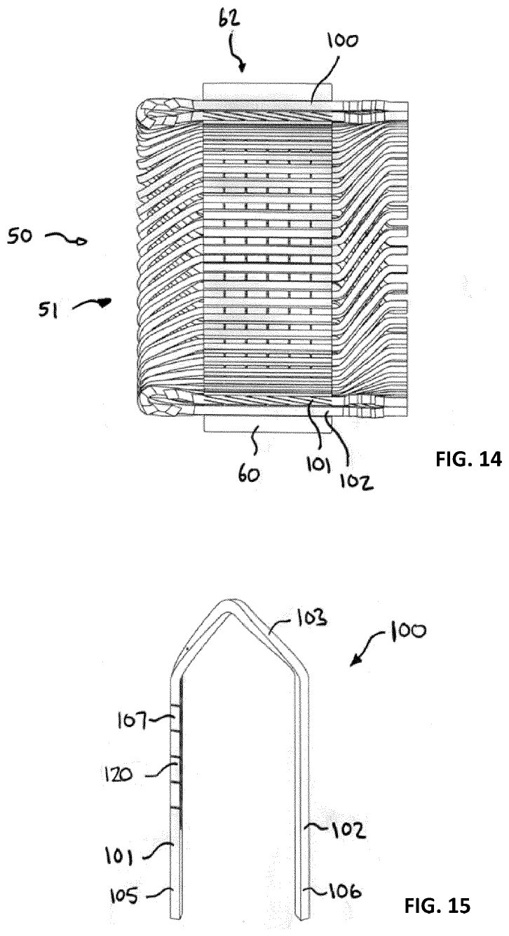

The winding element as shown in FIGS. 3 and 4 has a first intermediate portion 107 and a second intermediate portion 108. The first intermediate portion 107 is formed in the first leg 101. The second intermediate portion 108 is formed in the second leg 102. The first intermediate portion 107 extends between the first end portion 105 and the end turn portion 103. The second intermediate portion 108 extends between the second end portion 106 and the end turn portion 103. The number and configuration of intermediate portions of the winding element 100 may differ. For example, as will be described below with reference to FIGS. 14 and 15, the winding element 100 may comprise a single intermediate portion, or comprise three or more intermediate portions.

Although in the present arrangement the end turn is spaced from the intermediate portion, in embodiments, the end turn comprises an intermediate portion, and/or the intermediate portion extends into the end turn. Such an arrangement aids with enhancing cooling.

The length of the first intermediate portion 107 substantially corresponds to the active length 62. The first intermediate portion 107 aligns with the active length 62. The length of the second intermediate portion 108 substantially corresponds to the active length 62. The second intermediate portion 108 aligns with the active length 62.

The winding element 100 has a rectangular cross-sectional outer profile. Such an arrangement helps enable a compact winding 50. In embodiments, alternative cross-sectional outer profiles are envisaged. The cross-sectional outer profile of each of the first and second end portions 105, 106 and the first and second intermediate portions 107, 108 correspond with each other. The cross-sectional outer profile of the end turn portion 103 corresponds with the cross-sectional outer profile of the first and second intermediate portions 107, 108. The winding element 100 has a uniform cross-sectional area along the length. In embodiments, the cross-sectional area and outer profile may differ between portions of the element.

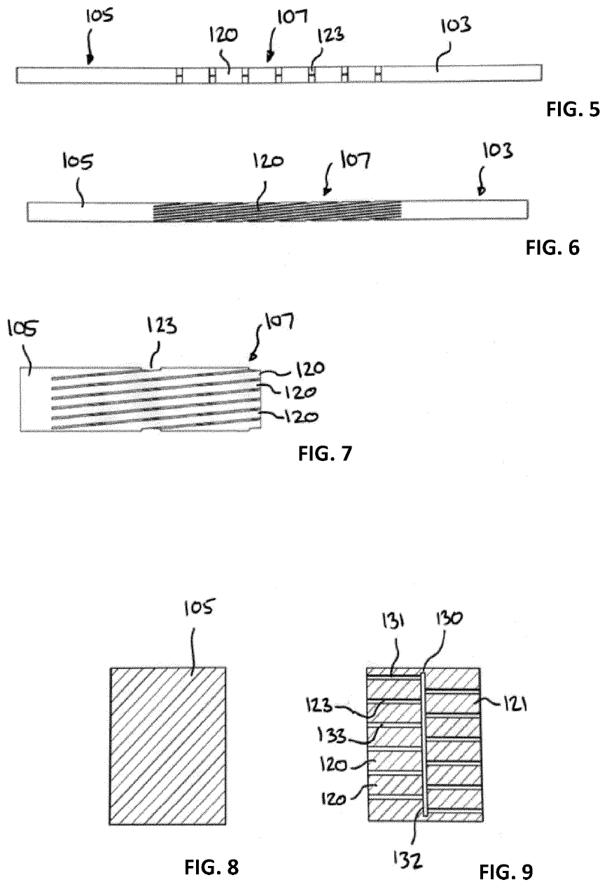

Referring now to FIGS. 5 to 9, the configuration of the intermediate portions 107, 108 will now be described in detail. In FIGS. 5 and 6, one intermediate portion 107 is shown between the first end portion 105 and the end turn portion 103. In FIG. 7, a close up view of part of the intermediate portion 107 is shown. In FIG. 8, a cross-sectional view of one end portion 105 is shown. In FIG. 9, a cross-sectional view of the intermediate portion 107 is shown.

The intermediate portion 107 is formed as part of a one piece component with the first end portion 105 and the end turn portion 103. The intermediate portion 107 comprises a plurality of intermediate conductive members 120. The first intermediate portion 107 comprises a plurality of first intermediate conductive members 120a. The second intermediate portion 108 comprises a plurality of second intermediate conductive members 120b. The intermediate conductive members 120 are elongate. The plurality of intermediate conductive members 120 extend generally in an axial direction. The conductive members 120 may be skewed, that is extending at an angle to the longitudinal axis of the electrical motor 10.

The plurality of intermediate conductive members 120 form a conductive arrangement 121. The conductive arrangement 121 defines a plurality of conductive paths along its length. The conductive arrangement 121 have an electrically parallel arrangement. The intermediate conductive members 120 each electrically communicate between the first end portion 105 and the end turn portion 103. The intermediate conductive members 120 have a substantially helical arrangement. Each intermediate conductive member 120 follows a wound path along the intermediate portion. As shown in FIGS. 5 and 6, each intermediate conductive member 120 extends at an arcuate angle direction to the longitudinal axis of the intermediate portion 107 along opposing sides as shown in FIGS. 6 and 7 and in a transverse direction to the longitudinal axis along front and rear sides as shown in FIG. 5. Each part of the intermediate conductive member 120 has a corresponding cross sectional area. Accordingly, the intermediate conductive member 120 has a consistent cross-sectional area along its length. It will be understood that the configuration of the intermediate conductive member 120 along its length, for example on each side of the intermediate conductive member 120 may be different in another embodiment. Accordingly, the dimensions and pitch of the intermediate conductive member 120 may be varied as will be described below. Such an arrangement may help to optimize overall performance.

The intermediate portion 107 helps to reduce or eliminate parasitic circulating currents, and so aids in reducing losses and improving efficiency. The intermediate conductive members 120 comprise a transposed configuration.

The intermediate conductive members are spaced from each other. Spacings 123 are defined between adjacent intermediate conductive members 120. The spacings 123 have a substantially helical arrangement. Each spacing follows a wound path along the intermediate portion 107. The spacings 123 are consistently spaced.

The intermediate portion 107 comprises an insulative arrangement 130. The insulative arrangement 130 acts to electrically insulate between adjacent intermediate conductive members 120. The insulative arrangement 130 is defined by the spacings 123 between adjacent intermediate conductive members 120. The insulative arrangement 130 comprises an insulative body 131. The insulative body 131 is disposed in the spacings 123 between the intermediate conductive members 120. The insulative body 131 is a single body, however in embodiments comprises a plurality of body portions. The insulative body 131 is omitted from FIGS. 5 to 7 for clarity, but is shown in FIG. 9.

The insulative body 131 is formed from an insulative material such as a polymer coating. The insulative material may be a film. The insulative body may comprise a plurality of layers. Insulative material may include one or more of polyamide, polyimide, polyamide-imide (or polyamide-polyimide), polyester, polyurethane, nylon, glass fibers, epoxy resins, polybutadiene resins, aramid paper and mica. In embodiments, the insulative arrangement 130 is formed in part or wholly by an air gap. For example, the insulative arrangement may comprise an insulative core formed from an insulative material, together with air gaps between adjacent intermediate conductive members.

A core 132 extends along the intermediate portion 107. The core 132 extends along the longitudinal axis of the intermediate portion 107. The core 132 forms part of the insulative body 131. The insulative body 131 comprises insulative barriers 133 between adjacent intermediate conductive members 120. The insulative barriers 133 extend along the length of the intermediate portion 107. The insulative arrangement has greater electrically insulative properties than the material of the plurality of elongate conductive members, for example in embodiments a metallic material may be used in dependence on the material used for the conductive members 120. The above arrangement aids with providing a high conductor to insulation ratio within stator slots, and so may act to help maximize the power-density. The winding element 100 is formed from a conductive material such as copper, aluminum and silver.

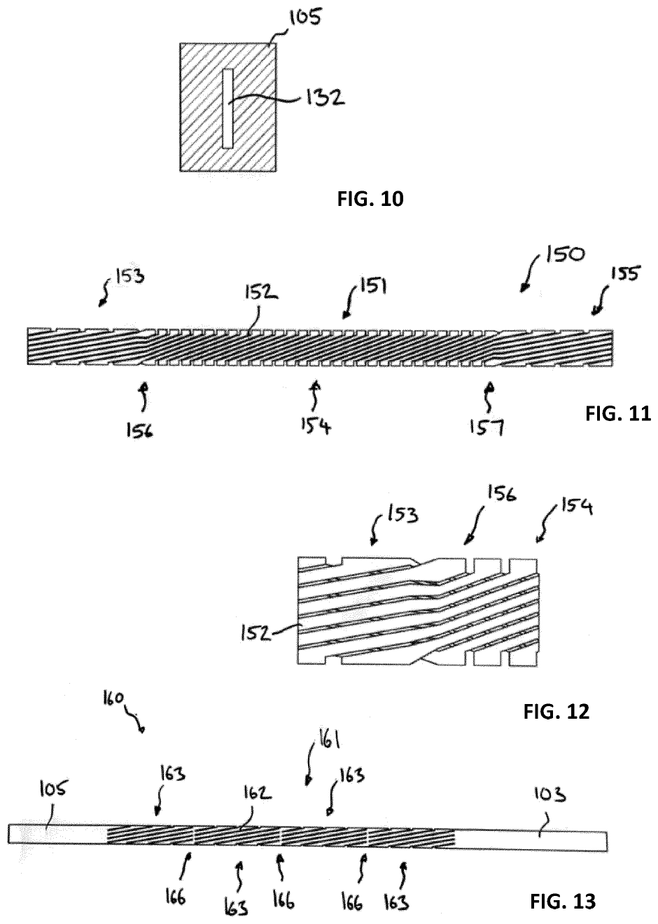

The insulative body 131 in the present arrangement extends along the length of the intermediate portion 107. As shown in FIG. 8, the insulative body 131 does not extend into the end portion 105. In embodiments, the insulative body 131 extends into one or both of the end portion 105 and end turn portion 103. For example, as shown in FIG. 10, in an embodiment the insulative core 132 extends in the end portion 105.

The first end portion 105 defines a first single conductive member. The first end portion 105 forms a single conductive path along its length. The first end portion 105 is a solid member. The second end portion 106 defines a second single conductive member. The second end portion 106 forms a single conductive path along its length. The second end portion 106 is a solid member. By providing solid members at each end of a segmented portion it is possible to aid thermal performance. The provision of solid end portions and/or end turn portions aids in the minimization of DC resistance of the winding element 100.

Each intermediate conductive member 120 defines a single conductive member. The intermediate conductive member 120 forms a single conductive path along its length. The intermediate conductive member 120 is a solid member. The arrangement helps the reduction of AC losses in regions of high magnitude time-varying magnetic flux density, for example in the active length.

By providing winding elements with differing configurations along their length, it is possible to aid reduction of DC loss components in the end portions resulting from a greater conductive cross sectional area with respect to the intermediate portion.

Referring now to FIGS. 11 and 12, another embodiment of a winding element 150 will be described. The winding element 150 is substantially the same as the embodiments of winding element described above, and so a detailed description will be omitted. In FIG. 11, part of the winding element 150 is shown with one intermediate portion 151. The number of intermediate portions may differ. The intermediate portion 151 is disposed between the end portion and the end turn portion.

The intermediate portion 151 is formed as part of a one piece component with the end portion and the end turn portion (not shown). The intermediate portion 151 comprises a plurality of intermediate conductive members 152. The intermediate conductive members 152 are elongate. The plurality of intermediate conductive members 152 extend generally in an axial direction.

The intermediate portion 151 comprises a plurality of intermediate segments, in this embodiment first, second and third intermediate segments 153, 154, 155. The number of intermediate segments 153, 154, 155 may differ. The intermediate segments 153, 154, 155 are disposed adjacent to each other in an axial direction. The number of intermediate conductive members 152 may differ between intermediate conductive segments 153, 154, 155.

The intermediate conductive members 152 extend between the end member and the end turn portion. Transition segments 156, 157 extend between adjacent intermediate segments 153, 154, 155. The intermediate segments 153, 154, 155 have a different geometry to the or each adjacent intermediate segment 153, 154, 155. The geometry of the intermediate portion 151 transitions between geometries at the transition segment 156, 157. The transition segments 156, 157 may blend the geometries of adjacent intermediate segments. The transition segments in embodiments are baffle segments as will be described below. A close up of one transition segment 156 is shown in FIG. 12.

In the embodiment as shown in FIGS. 11 and 12, the first intermediate segment 153 has a different pitch to the second intermediate segment 154. In the present embodiment the first intermediate segment 153 has a greater pitch than that of the second intermediate segment 154. The configuration of the third intermediate segment 155 corresponds to that of the first intermediate segment 153. Accordingly, the second intermediate segment defines a mid-segment of different geometry to two outer segments. Each intermediate segment may have a different pitch from each other. It will be understood that the change in geometry between segments is not limited to a change in pitch of the intermediate conductive members 152. For example, cross sectional dimensions of the intermediate conductive members 152 may differ along their length between different intermediate segments. The different geometry in embodiments includes differing lengths of intermediate segment, for example as shown in FIG. 11. The length of transition segments may differ. The number of intermediate conductive members 152 may differ between intermediate conductive segments 153, 154, 155.

In the arrangement shown in FIG. 11, the first and third intermediate segments 153, 155 extend to the extent of the active length. The intermediate portion differs in geometry along its length in dependence on the strength of the impinging magnetic field. Accordingly, it is possible to customize the geometry of the winding element in dependence on the impinging magnetic field along its length.

Referring now to FIG. 13, another embodiment of a winding element 160 will be described. The winding element 160 is substantially the same as the embodiments of winding element described above, and so a detailed description will be omitted. In FIG. 13, part of the winding element 160 is shown with one intermediate portion 161. The number of intermediate portions may differ. The intermediate portion 161 is disposed between the end portion 105 and the end turn portion 103.

The intermediate portion 161 is formed as part of a one piece component with the end portion 105 and the end turn portion 103. The intermediate portion 161 comprises a plurality of intermediate conductive members 162. The intermediate conductive members 162 are elongate. The plurality of intermediate conductive members 162 extend generally in an axial direction.

The intermediate portion 161 comprises a plurality of intermediate segments, in this embodiment first, second and third and fourth intermediate segments 163. The number of intermediate segments 163 may differ. The intermediate segments 163 are disposed adjacent to each other in an axial direction. Each intermediate conductive member 162 extends across the intermediate conductive members 162.

The intermediate conductive members 162 extend between the end member 105 and the end turn portion 103. In the present embodiment, the intermediate segments 163 have the same geometry to the or each adjacent intermediate segment 163. The geometry of adjacent intermediate segments 161 may differ. Transition segments extend between adjacent intermediate segments 163. The transition segments are baffles 166.

Each baffle, or baffle segment, 166 comprises a break in the spacing between adjacent intermediate conductive members 162. The baffle 166 forms a solid section. Each baffle segment 166 extends perpendicular to an elongate axis of the intermediate portion 160.

Each baffle segment 166 comprises a short section of solid conductor material which subdivide the intermediate portion 160 into the intermediate segments. The baffle segments 166 help provide mechanical support benefits to the transposed arrangement. The baffle arrangement divides the intermediate portion 160 into an even number of identical segmented sections. Such an arrangement helps provide electromagnetic benefits. In embodiments, the baffle arrangement divides the intermediate portion 160 into an odd number of identical segmented sections

As described above and now described with reference to FIGS. 14 and 15, when assembled each winding element 100 of the array 51 is received by the core pack 60. The stator defines the active length 62. The winding element 100 protrudes from the core pack 60 at each end. The end turn portion 103 extends from one side of the core pack 60 and the first and second portions 105, 106 extend from an opposing side of the core pack 60. As described above the first and second legs 101, 102 each have a corresponding intermediate portion 107, 108 with the corresponding first and second intermediate portions 107, 108 having the same geometry. In embodiments, the second intermediate portion 108 has a different geometry to the first intermediate portion 107. For example, the pitch of the first intermediate portion 107 in embodiments is greater than the pitch of the second intermediate portion 108. Alternatively, or in addition to, the number of intermediate conductive members may differ. For example, the number of intermediate conductive members of the first intermediate portion 107 in embodiments is greater than the number of intermediate conductive members of the second intermediate portion 108.

As shown in FIGS. 14 and 15, the first leg 101 is radially inward from the second leg 102. The first leg 101 is closer to the air gap between stator and rotor than the second leg 102. In the embodiment shown in FIGS. 14 and 15, the second leg 102 is formed without an intermediate portion. Using a solid leg aids reduction in DC losses, for example by providing a greater cross sectional area, and helps increase thermal conductivity resulting from a solid conductor having a lower thermal resistance it is possible to provide a system benefit.

Although in the above described embodiments the winding elements are discrete elements, it will be understood that in another embodiment, the winding elements are formed as a one-piece component. That is the winding elements are formed together, for example by additive manufacturing, such that no joints are defined between winding elements, also known as winding members. Different means of manufacturing are envisaged, for example metal additive manufacture, and advanced forming and cutting, such as laser engraving to form the spacing.

The arrangements described above are generally applicable to electromagnetic devices in which conductors are subject to time-varying magnetic fields.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the claims. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

1. An electrical winding element for an electrical machine comprising:
a first end portion comprising a first single conductive member;
a second end portion comprising a second single conductive member; and
an intermediate portion conductively connected between the first end portion and the second end portion comprising a plurality of intermediate conductive members arranged in an electrically parallel arrangement.

2. The electrical winding element of claim 1, further comprising:
a first leg with the first end portion;
a second leg with the second end portion; and
an end turn portion between the first leg and the second leg.

3. The electrical winding element of claim 2, wherein the intermediate portion is defined in the first leg between the first end portion and the end turn portion.

4. The electrical winding element of claim 3, wherein the end turn portion comprises a single elongate conductive member.

5. The electrical winding element of claim 2, wherein the intermediate portion is a first intermediate portion, and the electrical winding element comprises a second intermediate portion defined in the second leg comprising a plurality of second intermediate conductive members arranged in an electrically parallel arrangement.

6. The electrical winding element of claim 2, wherein the second leg extends at least substantially parallel to the first leg.

7. The electrical winding element of claim 1, wherein the first end portion, the second end portion, and the intermediate portion are formed as a one piece arrangement.

8. The electrical winding element of claim 1, wherein the first end portion, the second end portion, and the intermediate portion are integrally formed.

9. The electrical winding element of claim 1, wherein the first end portion, the second end portion, and the intermediate portion together define a conductive arrangement, and the electrical winding element comprises an insulative arrangement.

10. The electrical winding element of claim 9, wherein the insulative arrangement electrically insulates between the plurality of intermediate conductive members.

11. The electrical winding element of claim 1, wherein the intermediate portion comprises a transposed arrangement.

12. The electrical winding element of claim 1, wherein the plurality of intermediate conductive members comprise a helical arrangement.

13. The electrical winding element of claim 1, wherein the intermediate portion comprises at least two intermediate segments.

14. The electrical winding element of claim 13, wherein the intermediate portion comprises a baffle segment between adjacent intermediate segments of the at least two intermediate segments.

15. The electrical winding element of claim 13, wherein at least one intermediate segment comprises a different geometry than at least one other intermediate segment.

16. The electrical winding element of claim 15, wherein the different geometry comprises a different pitch.

17. The electrical winding element of claim 1, wherein the electrical winding element has a substantially constant cross-sectional area along a length of the electrical winding element.

18. The electrical winding element of claim 1, wherein the electrical winding element is a hairpin winding element.

19. The electrical winding element of claim 1, wherein each of the first single conductive member and the second single conductive member comprises a rectangular profile.

20. A stator for an electrical machine comprising a plurality of the electrical winding elements of claim 1.

21. A stator for an electrical machine comprising:
a stator core defining an active length; and
an electrical winding member having a first solid conductive end extending from the stator core, a second solid conductive end extending from the stator core, and an active section between the first solid conductive end and the second solid conductive end, wherein the active section comprises an elongate transposed conductive section at least substantially along a length of the active length of the stator core.

22. The stator of claim 21, wherein the first solid conductive end defines a joining end portion for joining to an adjacent joining end portion of an adjacent electrical winding member, and wherein the second solid conductive end defines an end turn portion.

23. The stator of claim 22, wherein the electrical winding member is a hairpin member comprising a first leg, a second leg, and the end turn portion between the first leg and the second leg, wherein the elongate transposed conductive section is on the first leg.

24. An electrical machine comprising:
at least one of the electrical winding element of claim 1, and
a stator comprising:
a stator core defining an active length, and
an electrical winding member having a first solid conductive end extending from the stator core, a second solid conductive end extending from the stator core, and an active section between the first solid conductive end and the second solid conductive end, wherein the active section comprises an elongate transposed conductive section at least substantially along a length of the active length of the stator core.

25. An electrical winding element for an electrical machine comprising:
a first solid conductive end section;
a second solid conductive end section; and
a transposed conductive intermediate elongate section conductively connected between the first solid conductive end section and the second solid conductive end section.
